(19) United States
(12) Patent Application Publication
(10) Pub. No.: US 2005/0174732 A1
(43) Pub. Date: Aug. 11, 2005

(54) Main unit of a computer

(76) Inventor: Fang-Cheng Lin, Jhonghe (TW)

Correspondence Address: Ann Tsai;PMB 174, Suite 137, 931 West 75th Street, Naperville, IL, 60565, US

(21) Appl. No.: 10/773,047

(22) Filed: Feb. 6, 2004

(51) Int. Cl. G06F 1/20

(52) U.S. Cl. 361/695; 361/687

(57) ABSTRACT

A main unit of a computer includes a frame case and a cooling device. The frame case is provided with an air inlet at one end thereof and an air outlet at another end thereof. The cooling device further at least including a fan, a radiator and an air guide unit. The air guide unit is hollow with an end thereof connecting with the air inlet and another end thereof connecting with the fan and the fan is joined to the radiator such that the cold air current outside the frame case can be flew with the fan from the air guide unit to the radiator for removing heat generated by the central processing unit. Further, the air current together with the heat can move out of the air outlet so that convection in the frame case can be formed circularly and the heat in the frame case can be reduced largely so as to enhance effect of heat dissipation.

### BACKGROUND OF THE INVENTION

1. Field of the Invention

The present invention is related to a main unit of a computer and particularly to a main unit being associated with a cooing device for enhancing removal of heat generated by the central processing unit.

2. Brief Description of Related Art

It is known that the computer has powerful operation capability and it gives us a great convenience at work and in daily lives. Hence, the computer is an indispensable device for us. Accordingly, equipment and components related to the computer, such as Central Pressing Unit (CPU), power supply device, hard disk, compact disk driver, video graphics adaptor and various electronic components on the main board, change rapidly. However, the equipment and components related to the computer generate a great deal of heat during the computer running and the phenomenon results in high temperature of the main unit. Consequently, the computer is unable to operate normally if the high temperature is not possible to be lowered down properly. Even seriously, the equipment and the components will be damaged. The traditional way of heat removal is a cooling device composed of a fan a radiator is attached to the CPU for dissipating heat generated by the CPU. But, the traditional frame case of a main unit for the computer provides a close configuration and the fresh cold air outside the frame case is not possible to be taken into the frame case so that temperature of the air current in the frame case gets higher in spite of the cooing device removing the heat of the CPU effectively. In order to improve preceding deficiency, a suction opening with a suction fan is provided at rear side of the frame case for drawing the hot air current out of the frame case. Because the cold air from outside is unable to be introduced and occur a state of convention, the effect of the suction fan is very limited. How to discharge heat in the frame case out effectively and to introduce outside cold air into the frame case so as to form a state of convection is a vital subject has to be cared.

### SUMMARY OF THE INVENTION

An object of the present invention is to provide a main unit of a computer in which the frame case thereof makes a convection cycle of air current possible so that the temperature in the frame case can be lowered largely and the CPU can obtain an excellent effect of heat dissipation.

In order to achieve the preceding object, the main unit according to the present invention includes a frame case and a cooling device. The frame case is provided with an air inlet at one end thereof and an air outlet at another end thereof. The cooling device further at least including a fan, a radiator and an air guide unit. The air guide unit is hollow with an end thereof connecting with the air inlet and another end thereof connecting with the fan and the fan is joined to the radiator such that the cold air current outside the frame case can be flew with the fan from the air guide unit to the radiator for removing heat generated by the CPU. Further, the air current together with the heat can move out of the air outlet so that convection in the frame case can be formed circularly and the heat in the frame case can be reduced largely so as to enhance effect of heat dissipation.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a main unit of a computer according to the present invention;

FIG. 2 is an exploded perspective view of the main unit of the present invention; and

FIG. 3 is a plan view illustrating an embodiment of the present invention.

### DETAILED DESCRIPTION OF THE PREFERRED EMBODIMENT

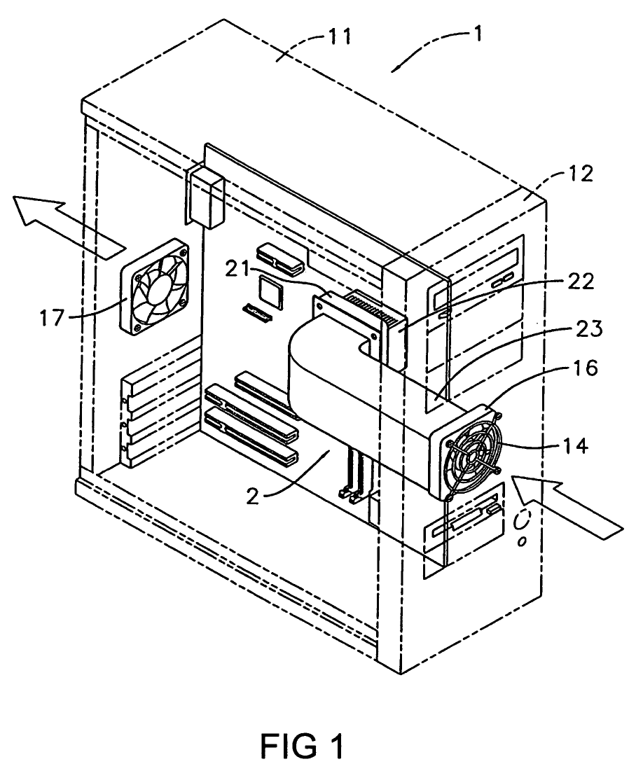

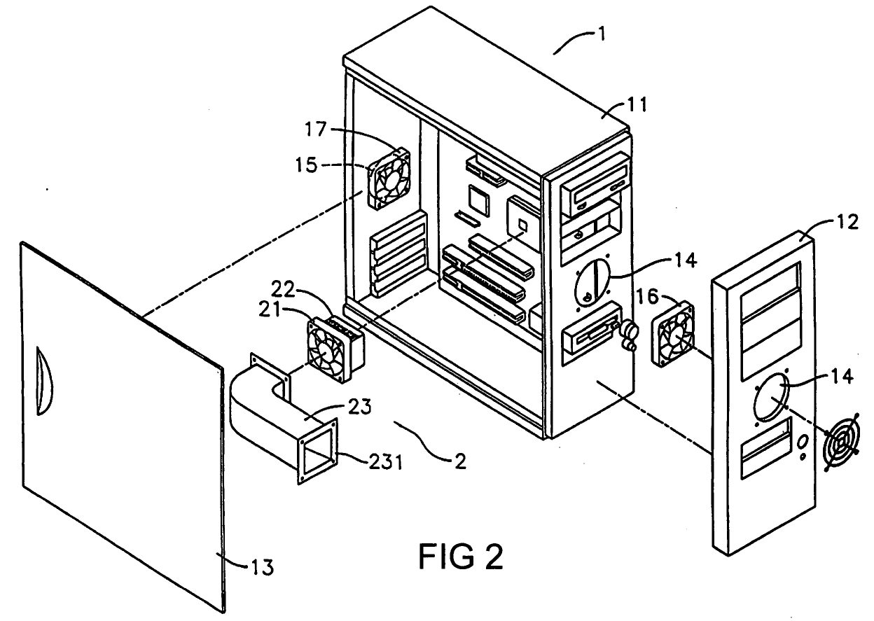

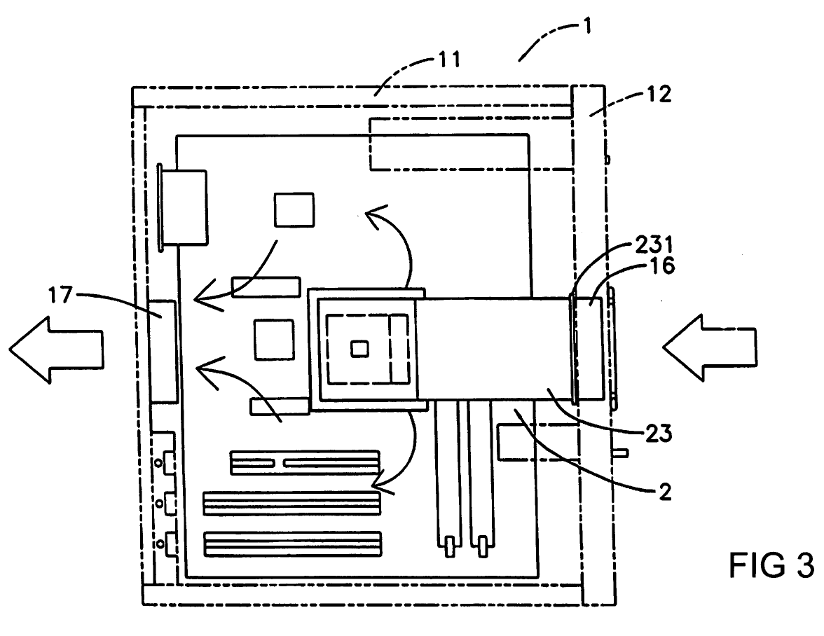

Referring to FIGS. 1, 2 and 3, the main unit of a computer according to the present invention includes a frame case and a cooling device in the frame case.

Wherein, the frame case 1 is composed of a frame 11, a panel 12 and two lateral plates 13, which are conventional, and no detail will be described further. A special feature of the present invention resides in that a common air inlet 14 is provided at the frame 11 and the panel 12 and an air outlet 15 is located at the rear side of the frame 11.

The cooing device 2 is composed of a fan 21, a radiator 22 and an air guide unit 23. The radiator 22 includes a base and a plurality of fins extending upward from the base. The base at the bottom thereof is joined to the central processing unit and the fan is attached to the fins. The air guide unit 23 is hollow with an end thereof having a connection part 231 being joined to the air inlet 14 at the frame case with fixing components. Another end of the air guide unit 23 is connected to fan 21 with fasteners such that cold air current from outsides can enter the frame case 1 via the air guide unit 23. Hence, the heat generated by the CPU can be removed largely with the air current due to the fan blowing the cooling device and the air current together with the heat can move out of the air outlet. In this way, it results in convection in the frame case 1 circularly to reduce the heat in the frame case 1 and enhance effect of heat dissipation.

Further, a forced fan 16 is associated with the connection part 231 of the air guide unit 23 at the air inlet 14 of the frame casing 1 and a discharge fan 17 is disposed at the air outlet 15. The air current stagnating in the frame case 1 can be removed by way of the forced fan 16 impelling the intake air and the discharge fan 17 dragging the outgoing air so as to constitute a state of convection as well for further enhancing the effect of heat dissipation.

In addition, a filter net (not shown) can be provided at the air inlet 14 for blocking dust and foreign substance in the air entering the frame case so as to prevent the electronic components on the main board from being stained and occur problem of short circuit.

While the invention has been described with referencing to a preferred embodiment thereof, it is to be understood that modifications or variations may be easily made without departing from the spirit of this invention, which is defined by the appended claims.

1. A main unit of a computer, comprising
a frame case with two ends, being provided with an air inlet at one of the ends and a an air outlet at the other one of the ends;
a cooling device, at least including a fan, a radiator and an air guide unit, the air guide unit being hollow with an end thereof connecting with the air inlet and another end thereof connecting with the fan, which is joined to the radiator.

2. The main unit of a computer as defined in claim 1, wherein the air guide unit is provided with a connection part to connect with the air inlet.

3. The main unit of a computer as defined in claim 1, wherein a forced fan is disposed between the air inlet and the air guide unit and a discharge fan is disposed at the air outlet.

4. The main unit of a computer as defined in claim 1, wherein a filter net is disposed at the air inlet for blocking dust and foreign substance in the air entering the frame case so as to prevent the electronic components on the main board from being stained and occur problem of short circuit.

5. The main unit of a computer as defined in claim 1, wherein the air guide unit is a flexible hose.
